(19) United States
(12) Patent Application Publication
(10) Pub. No.: US 2026/0030690 A1
(43) Pub. Date: Jan. 29, 2026

(54) SYSTEMS AND METHODS FOR GENERATING RECOMMENDATIONS FOR PLANTING SEEDS IN GROWING SPACES

(71) Applicant: CLIMATE LLC, St. Louis, MO (US)

(72) Inventors: Dongming JIANG, Chesterfield, MO (US); Yule PAN, Chesterfield, MO (US); Bing LIU, Chesterfield, MO (US); Guomei WANG, Ballwin, MO (US); LeAnn GUERIN, St. Peters, MO (US); Matthew DIMMIC, Wildwood, MO (US)

(21) Appl. No.: 19/276,298

(22) Filed: Jul. 22, 2025

Related U.S. Application Data
(60) Provisional application No. 63/674,930, filed on Jul. 24, 2024.

(51) Int. Cl. G06Q 50/02; G06F 16/248; G06F 16/28

(52) U.S. Cl. CPC G06Q 50/02; G06F 16/248; G06F 16/287

(57) ABSTRACT

A system for generating a seed recommendation is disclosed. The system includes a processor, a display, and a memory. The processor may be configured to retrieve genetic data having a first dimensionality; generate embeddings corresponding to the genetic data, the embeddings having a second dimensionality lower than the first dimensionality; categorize the embeddings into one or more clusters, such that genetically similar seed products are assigned to the same cluster based on the embeddings of the genetically similar seed products; using agronomy data, assign additional seed products to the one or more clusters; generate a recommendation to a grower to plant a first seed categorized in a first cluster, when the grower has previously planted a second seed in the first cluster; and cause the display to display the generated recommendation to the grower.

### CROSS-REFERENCE TO RELATED APPLICATION

This application claims priority to U.S. Provisional Application No. 63/674,930, filed Jul. 24, 2024, the content of which is incorporated herein by reference in its entirety.

### FIELD

The present disclosure generally relates to systems and methods for generating recommendations for planting seeds in growing spaces, and more particularly relates in one embodiment to an artificial-intelligence based algorithm to generate recommendations to growers to plant a particular type or brand of seed in a particular growing space, as described below.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. For example, corn may be grown by a farmer in a field owned, leased, or managed by the farmer, and the corn grown and harvested from the field is then sold (e.g., for consumption by livestock, etc.). Consequently, farmers and other growers often seek to plant particular seeds based on specific aims of the farmers (e.g., corn versus soybeans, etc.), specific climate conditions of the fields (e.g., drought tolerance, etc.), specific disease resistance, and also, based on performance of the seeds in terms of yield. Presently, a large number of seed varieties, marketed under various brand names, are commercially available. Farmers may rely on past performance of seeds in their fields, or on recommendations based on conditions of their fields, by seed providers, in selecting specific seed varieties for planting.

Genetically similar seed varieties, exhibiting similar phenotypic traits, may be of particular interest to the grower. For example, when a particular type or breed of seed grows well on a grower's field, the grower may be interested in other genetically similar breeds, which likely will also grow well on the field. Therefore, it may be advantageous for the seed provider to recommend genetically similar seed varieties to the ones the grower has planted previously that have yielded good results. However, large genetic data sets present a significant challenge. For example, genomic data of a single breed may contain billions of base pairs. Comparing billions of data points manually to find genetically similar seed varieties would be impossible. Even leveraging computers and automation to compare these large data sets is resource-intensive and such methods do not scale easily. Currently, for example, there are tens of thousands of different corn varieties in existence. Without the ability to scale, these computer-implemented methods are not useful commercially. Therefore, there exists a need in the art for novel algorithms that can efficiently process genetic information at-scale.

The above information is presented as background information only to assist with an understanding of the instant disclosure. No determination has been made, and no assertion is made, as to whether any of the above might be applicable as prior art with regard to the instant disclosure.

### SUMMARY

This section provides a general summary of the disclosure and is not a comprehensive disclosure of its full scope or all of its features.

Example embodiments of the present disclosure generally relate to the above-described system and method. In one example embodiment, such a system generally includes at least one processor; a display communicatively coupled to the at least one processor and configured to display a result based on computations performed by the at least one processor; and a memory communicatively coupled to the at least one processor, the memory storing executable instructions, which when executed by the at least one processor, cause the at least one processor to: retrieve genetic data of two or more seed products from a database, the genetic data having a first dimensionality; using a first artificial-intelligence based algorithm, generate embeddings corresponding to the genetic data, the embeddings having a second dimensionality lower than the first dimensionality; categorize the embeddings into one or more clusters using a clustering algorithm, such that genetically similar seed products among the two or more seed products are assigned to the same cluster based on the embeddings of the genetically similar seed products; using agronomy data and a second artificial-intelligence based algorithm, assign additional seed products to the one or more clusters; generate a recommendation to a grower to plant a first seed categorized in a first cluster, when the grower has previously planted a second seed in the first cluster; and cause the display to display the generated recommendation to the grower.

In another example embodiment, a disclosed method includes the steps of retrieving genetic data of two or more seed products from a database, the genetic data having a first dimensionality; using a first artificial-intelligence based algorithm to generate embeddings corresponding to the genetic data, the embeddings having a second dimensionality lower than the first dimensionality; categorizing the embeddings into one or more clusters using a clustering algorithm, such that genetically similar seed products among the two or more seed products are assigned to the same cluster based on the embeddings of the genetically similar seed products; using agronomy data and a second artificial-intelligence based algorithm to assign additional seed products to the one or more clusters; generating a recommendation to a grower to plant a first seed categorized in a first cluster, when the grower has previously planted a second seed in the first cluster; and causing a display to display the generated recommendation to the grower.

In particular, one embodiment disclosed herein is a system for generating a seed recommendation to a grower. The system implements a novel artificial-intelligence based algorithm to compare and cluster seed varieties or brands based on genetic and agronomic data. This algorithm allows a computer-implemented system to efficiently process genetic data, which allows the algorithm to be deployed at-scale.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system in which one or more aspect(s) of the present disclosure may be implemented;

FIG. 2 illustrates a schematic diagram of a machine-learning algorithm to generate genetic embeddings;

FIG. 3 illustrates a schematic diagram of a machine-learning algorithm to generate seed product recommendations based on products from multiple competitor companies;

FIGS. 4A and 4B illustrate two views of an example logical organization of sets of instructions in main memory when an example mobile application is loaded for execution;

FIG. 5 illustrates a block diagram that illustrates a computer system upon which one or more embodiments of the present disclosure may be implemented; and

FIG. 6 illustrates a flow chart illustrating a method of the present disclosure in one embodiment.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

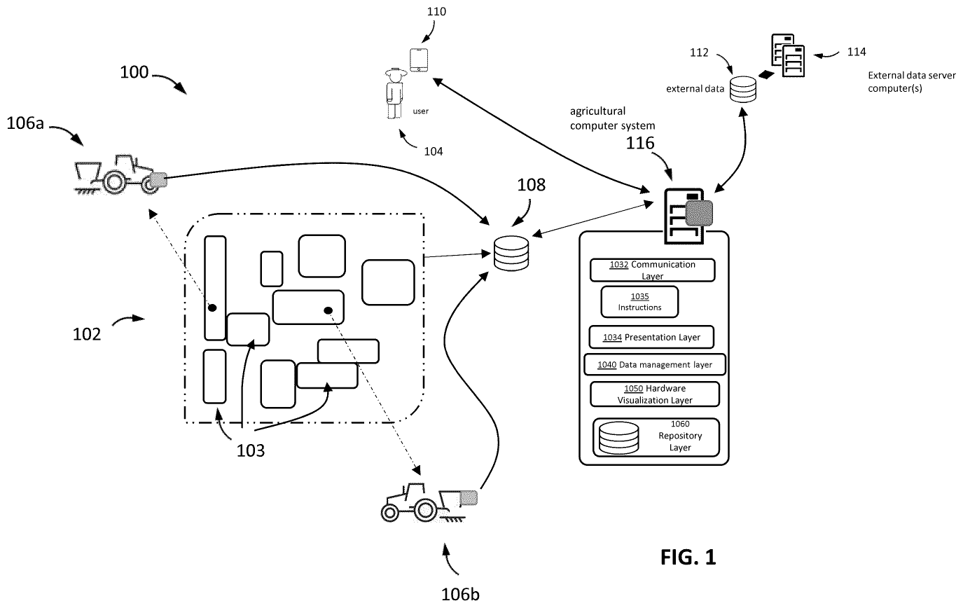

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, types of seeds/crops; available candidate seeds; types and/or locations of growing spaces, and/or privacy and/or data requirements; etc.

The system 100 generally includes various growing spaces 103 (e.g., fields plots, etc.), for example, associated with a user 104 (e.g., a grower, etc.). The growing spaces 103 are shown in solid lines in a field 102. The growing spaces 103 may each include, without limitation, at least a portion of one or more fields (e.g., commercial fields, research/test fields, etc.), greenhouses, shade houses, nurseries, etc.

The growing spaces 103 may be part of any type of plots or fields in which crops are grown and harvested, or may cover multiple plots or fields. The growing spaces 103 may be owned by the user 104, or otherwise operated and/or managed by the user 104, for example, in the business of growing, harvesting, and selling crops. In connection therewith, the user 104 may be associated with planting seeds into the growing spaces 103, and then imposing management practices as the seeds grow into plants (e.g., in season, etc.) (e.g., through treatments, irrigation, etc.), and then harvesting the crops with a variety of different farm equipment (e.g., planters, sprayers, combines, pickers, etc.) (as explained below) 106.

In connection with the above, data (e.g., agronomic data, etc.) is gathered at or from the growing spaces 103. The agronomic data may be gathered manually, or automatically, for example, by farm equipment, etc. The agronomic data may include plant/seed identifiers, plant/seed types, crop type, seed products, and/or variety identifiers, plant performance (e.g., yield, height, moisture, maturity, etc.) (e.g., at one or more regular or irregular interval(s), etc.), soil conditions (e.g., moisture, pH level, etc.), weather conditions (e.g., precipitation, temperature, precipitation, sun exposure, humidity, classes, etc.), plant growth stages, planting dates, soil data, growing temperature days, location data (e.g., different zones designations (e.g., maturity zones, environmental zones, weather zones, etc.), field identifiers, treatments, and other suitable data to identify the seed/plant, a performance of the seed/plant, etc., in the growing spaces 103.

Although agronomic data is described in some example embodiments with reference to growing spaces 103, it should be appreciated that agronomic data may be gathered at the plot level, at the field level (e.g., for more than one plot, etc.), at a region level (e.g., for multiple fields and multiple plots, etc.), etc.

With continued reference to FIG. 1, the system 100 also includes farm equipment 106, a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the farm equipment 106 (broadly, agricultural apparatus) may include, without limitation, harvesting devices, sprayers, planters, seeders, etc., each disposed in the growing spaces. For example, the farm equipment 106 may include, for example, planters 106a and 106b (as shown in FIG. 1), a sprayer, a tiller, an irrigator, a combine, picker, or other types of machines for performing one or more suitable tasks in the growing spaces 103. It should also be appreciated that a different number and/or type of farm equipment, which may be distributed differently among the different growing spaces 102, may be included in other system embodiments.

The farm equipment 106 is configured to measure, capture, or identify data, and additionally to compile data, which is specific to the defined task of the machine, the crop and/or growing spaces 102 as the equipment is performing the defined task(s) related to the crop or growing space 102, etc. The data may include, without limitation, rates, soil compositions, times, dates, yield, weights, applications, moisture content, volumes, flow, or other suitable data, etc., relating to planted seeds, treatments, irrigation, harvested crops, etc. Moreover, in this example, the farm equipment 106 may be configured to track its locations at given times, as each traverses the growing spaces 103, as expressed in latitude/longitude coordinates, or otherwise, and to correlate the locations to other data gathered/compiled by the farm equipment 106 (e.g., permitting the data to be correlated to a specific plant and/or seed based on planting data for the growing spaces, etc.).

The farm equipment 106 may be configured to measure, capture or identify soil information, such as a soil moisture content, pH level, drainage level, etc. For example, the farm equipment 106 may include one or more instruments for measuring a current moisture level of the soil, for measuring a rate of water drainage from the soil over time, measuring pH levels in the soil, etc. Additionally, or alternatively, the growing spaces 103 may include one or more instruments for measuring soil conditions to generate soil data, whereby the user 104 and/or soil investigator may obtain soil samples from the growing spaces 103 periodically to determine soil conditions, etc. It should be appreciated that the farm equipment 106 and/or the instruments at the growing spaces 103 may be configured to capture weather data, such as, for example, temperature, precipitation, sun exposure, humidity, wind, etc.

Alternatively, or in addition, soil data and/or weather data specific to the growing spaces 103 may be obtained from one or more databases, including, for example, public databases from the external data 112 of an external data server 114. One example database may include the SSURGO database for certain types of soil data, while another example database may include the ERA5 database for certain types of weather data. The soil data may be for a present season, or a recent history of the growing spaces 103, while the weather data may be for a number of previous years, in general or at specific time periods throughout the year.

The farm equipment 106 is further configured herein to transmit the collected/gathered data to the data server 108, depending on the particular growing space(s) for which the data relates. That said, a different number of data servers 108 may be included in other system embodiments, with the different data servers 108 each being specific to certain ones (or more) of the growing spaces 103, or not.

It should be understood that the data related to the growing spaces 103 and crops/seeds therein may further be identified, measured, collected and/or reported in one or more different manners. For example, the user 104 may inspect the crops and/or growing spaces 103 to observe performance of crops. Crop and/or seed product performance may be identified via visual inspection, a specified test protocol, and/or any other suitable techniques for determining how crop growth has performed, such as a crop yield, crop height, crop moisture, crop maturity, etc. The crop and/or seed product performance observations may indicate a level of performance on a scale, or may include numerical measurements of crop performance according to measurement protocols (such as average volume of crop yield, average crop height, etc.), etc. The crop and/or seed product performance observations may then be communicated to the data server 108 in any suitable manner. For example, the crop and/or seed product performance observations may be logged or reported through a data input tool, such as, for example, the CLIMATE FIELDVIEW, commercially available from Climate LLC, Saint Louis, Missouri, etc. Crop performance and/or seed product performance data may be obtained from other suitable sources, such as commercial research trials, field trials, etc., (which may study growth and performance of different crop types and/or seed products under different growing conditions at various locations of growing spaces).

Apart from the data generated and/or collected from the growing spaces 103, the seeds planted in the growing spaces 103 are associated with a variety of different data, as it relates to the phenotypic and genotypic features thereof. For example, in connection with breeding the particular seed (e.g., genetic information, etc.), certain data related to relative maturity (RM), height, yield, drought tolerance, seed supply data (e.g., indicating available seed products, etc.), etc., is compiled. The data may be identified through a seed catalog entry for the specific seed. The data is stored and/or collected by the data server 108. In addition, the data server 108 includes a variety of different data specific to the genotypic information of the seeds, and the specific varieties of the seed is included in the data server 108. The genotypic data may include the specific identifiers and genetic sequences (in whole or in part), trait stacks, markers, and other data indicative of the specific variety, as compared to other varieties at a genetic level, etc.

It should be understood that the data server 108 may be configured to access and/or retrieve soil data and/or weather data from the external data server 112, as appropriate and/or desired for the growing spaces 103, over one or more periods of time. The data server 108 may be configured to also access and/or retrieve other data as described herein.

In addition, the received agricultural data may be associated with a wide range of feature data related to the seeds, environmental and/or testing conditions, and yield properties. In connection therewith, general categories of such feature data may relate to weather, maturity group zones, soil conditions, environmental classifications, field management practices, and/or overall genetic-by-environment (GxE features) that capture non-additive interactions between genetic and environmental features. Other categories of such feature data may include genetic-by-management features (GxM) and genetic-by-environment-by-management features (GxExM), which respectively capture non-additive interactions between genetic and management features, and interactions between genetic, environment, and management features. As used herein, GxE is a general term of engineered features that take into account variability due to a variety of seeds performing differently under different environmental conditions, which may also consider management features.

The data server 108, in turn, is configured to store the received data in one or more data structures. In general, in this example embodiment, the data server 108 is configured to store data by year (e.g., Year_X, Year_X+1, etc.), which corresponds to the different growing years (e.g., 2019, 2020, 2021, etc.) for the growing spaces 103 (and/or trials, plots, fields, etc., within the growing spaces, etc.). Then, for each year, the data includes data for each of the plots/fields/growing spaces including, for example (and without limitation), performance of multiple different crop types and varieties in various growing spaces (such as crop yield, crop height, crop maturity, crop moisture, etc.), identifiers, brands for seeds, planting dates, growing temperature days, growing mode of action, prior crops, types of traits or trait stacks, treatments, positions/distributions of seeds in the growing spaces 103 (e.g., seeding rates, etc.), location definitions of or within the growing spaces 103 (e.g., field boundaries, latitude and longitude, centroid of a plot or other boundary, etc.), acreage of the growing spaces, populations of seeds planted in the growing spaces 103, yields and harvest grain moisture (e.g., based on location and seed products, etc.), etc. The data may also include soil conditions (e.g., soil moisture, pH levels, drainage levels, etc.), field elevations (which may include slopes of a plot, surrounding terrain information, etc.), precipitation amounts, relative humidity, temperature, solar radiation, irrigation amounts, management practices (e.g., crop rotation, fungicide application, tiling, drainage, etc.) or any other data indicative of the growing conditions for the seeds/plants in the given growing spaces 103, etc.

It should be appreciated that any available and/or desired data may be collected with regard to the growing spaces 103 and/or the crops planted therein.

Given the above, in this example embodiment, the agricultural computer system 116 is programmed, or configured, to receive a request for a seed recommendation related to seeding of a target growing space. For example, the user 104 may make the request with regard to one or more of the growing spaces 103 (which is then a “target growing space”), via the communication device 110, where the request then includes one or more candidate seed types, and a location of the one or more growing spaces 103. In various implementations, the user 104 may submit the request for the seed recommendation, prior to a seed planting date for a next growing season (e.g., via the CLIMATE FIELDVIEW application, etc.).

In this exemplary embodiment, the agricultural computer system 116, then, is configured to issue an output as a recommendation to the user 104 (e.g., via a transmission to a communication device 110 associated with the user 104, etc.) of a recommended seed for planting in the target growing space.

With continued reference to FIG. 1, in this example embodiment, the agricultural computer system 116 is programmed, or configured, to issue the seed recommendations to the user 104 in one or more forms. In particular, the seed recommendations may be provided in combination with one or more probabilities in an interface displayed to the user 104 at the communication device 110 (e.g., via the CLIMATE FIELDVIEW application, etc.).

The seed recommendation may then be selected by the user 104 (e.g., via the CLIMATE FIELDVIEW application, etc.), where the user 104 may then order and/or purchase the seed product(s), for instance, via the agricultural computer system 116, etc. (e.g., whereby the agricultural computer system 116 receives the order, purchase request, etc., from the user 104, in response to output of the seed portfolio decision to the user 104 and a corresponding agreement to the decision and/or recommendation by the user 104, etc.). The agricultural computer system 116 may then direct the selected seeding(s) to the user 104 (e.g., delivering the portfolio of seeds to the target growing space, etc.). Further, the candidate seeds may be applied, by the user 104 or other party, for example, to the target growing space (e.g., as represented by one or more plots, fields, etc.). This may include the user 104 receiving the seeds and operating farm equipment (e.g., one or more of farm equipment 106, etc.) to plant the seeds in the target field. Alternatively, this may include the agricultural computer system 116 generating instructions based on the seed recommendation and providing the instructions to the farm equipment 106, for example, whereby the farm equipment 106 is configured to operate, in response to the instructions, to seed the target growing space (e.g., upon delivery of the recommended seeds to the farm equipment 106, etc.). In one or more embodiments, the farm equipment 106 (e.g., a seeder, planter, etc.) in the target growing space may be controlled automatically, through one or more scripts generated by the agricultural computer system 116, in connection with the instructions.

In an embodiment, the agricultural computer system 116 is programmed with or comprises a communication layer 1032, instructions 1035, a presentation layer 1034, a data management layer 1040, a hardware/virtualization layer 1050, and a data repository layer 1060. “Layer,” in this context, refers to any combination of electronic digital interface circuits, microcontrollers, firmware, such as drivers, and/or computer programs, or other software elements.

Communication layer 1032 may be configured to perform input/output interfacing functions including sending requests to the data server 108 and/or to remote sensor(s) for field data from the field, etc. Communication layer 1032 may be configured to send the received data to the data repository layer 1060 to be stored (e.g., in agricultural computer system 116, etc.). Presentation layer 1034 may be configured to generate a graphical user interface (GUI) to be displayed on a communication device, via one or more applications (e.g., to interact with the agricultural computer system 116, etc.), or other computers that are coupled to the agricultural computer system 116 through the network(s). The GUI may comprise controls for inputting data to be sent to the agricultural computer system 116, generating requests for models and/or recommendations, and/or displaying recommendations, notifications, models, and other data.

Data management layer 1040 may be configured to manage read operations and write operations involving the repository layer 1060 and other functional elements of the system 100, including queries and result sets communicated between the functional elements of the system and the repository layer 1060. Examples of data management layer 1040 include JDBC, SQL server interface code, and/or HADOOP interface code, among others. The repository layer 1060 may comprise a database. As used herein, the term “database” may refer to either a body of data, a relational database management system (RDBMS), or both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to, ORACLE®, MYSQL, IBM® DB2, MICROSOFT® SQL SERVER, SYBASE®, and POSTGRESQL databases. That said, any database may be used that enables the systems and methods described herein.

When data is not provided directly to the agricultural computer system 116, for example, via sensors, satellites, etc., the user 104 may be prompted via one or more user interfaces on a communication device (served by the agricultural computer system 116) to input such data to the agricultural computer system 116.

In an embodiment, models and data may be stored in the repository layer 1060. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values indicative of field boundaries that can serve as the basis of computer-implemented output data displays, or machine control, among other things.

With continued reference to FIG. 1, in an embodiment, instructions 1035 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 1035 may comprise a set of pages in RAM that contain instructions which, when executed, cause determining likelihoods of occurrence of one or more diseases as described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 1035 also may represent one or more files, or projects of source code, that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein.

Hardware/virtualization layer 1050 comprises one or more central processing units (CPUs), memory controllers, and other devices, components, or elements of a computer system, such as volatile or non-volatile memory, non-volatile storage, such as disk, and I/O devices or interfaces, etc. The hardware/virtualization layer 1050 also may comprise programmed instructions that are configured to support visualization, virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices associated with different users/growers. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs, or other software elements that are loaded into and executed using one or more general-purpose computers, will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, the user 104 interacts with the agricultural computer system 116 using a communication device 110 (or other computing device) configured with an operating system and one or more applications or apps. The communication device 110 also may interoperate with the agricultural computer system 116 independently and automatically under program control or logical control and direct user interaction is not always required. The communication device 110 broadly represents one or more of a smart phone, PDA, tablet computing device, laptop computer, desktop computer, workstation, or any other computing device capable of transmitting and receiving information and performing the functions described herein. The communication device 110 may communicate via a network using a mobile application stored on the communication device 110, and in some embodiments, the communication device 110 may be coupled using a cable or connector to one or more sensors and/or other apparatus in the system 100. The particular user may own, operate or possess and use, in connection with system 100, more than one communication device 110 at a time.

The application associated with the communication device 110 may provide client-side functionality, via the network to one or more mobile computing devices. Again, the communication device may 110 access the application, via a web browser or a local client application or app. The communication device 100 may transmit data to, and receive data from, one or more front-end servers, using web-based protocols, or formats, such as HTTP, XML and/or JSON, or app-specific protocols. In an example embodiment, the data may take the form of requests (e.g., filter criteria, selections, etc.) and user information input, such as data (e.g., disease observation, etc.), into the communication device 110.

A commercial example of the application described above is CLIMATE FIELDVIEW, commercially available from Climate LLC, Saint Louis, Missouri. The CLIMATE FIELDVIEW application and associated tools, or other applications, may be modified, extended, or adapted to include features, functions, and programming that have not been disclosed earlier than the filing date of this disclosure. In one embodiment, the application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

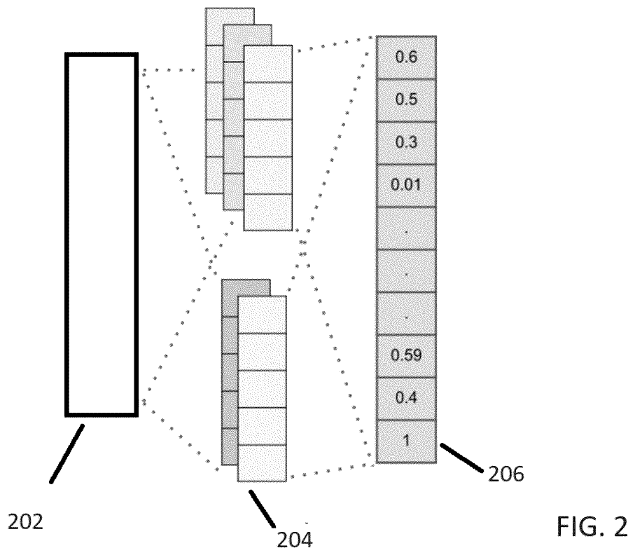

FIG. 2 illustrates a schematic diagram of a machine-learning algorithm to generate genetic embeddings. As shown in FIG. 2, genetic data 202 is input into the trained machine-learning algorithm 204 to generate the output genetic embeddings 206. In one example, the genetic data 202 may be represented as a vector of approximately 5,000 dimensions, i.e., size 5,000. Each number in the vector represents a specific genetic marker, and each vector corresponds to a particular seed product.

Genetic markers are DNA sequences in a known location on a chromosome, useful for identifying individuals, species, or traits. These markers can range from a few base pairs to longer DNA sequences and are instrumental in creating genetic maps and studying the genetic underpinnings of phenotypic variations, such as disease resistance or grain yield. An organism's genome, which is all of its genetic information, plays a critical role in determining phenotypic traits like crop yield and plant height. DNA, the molecule carrying this genetic information, is composed of nucleotides (A, G, C, T) and replicates with high fidelity. However, entire genomes are difficult to analyze and manipulate due to the enormous amount of information contained within them. Thus, researchers will often reduce the dataset by examining only certain genetic markers within the genome. Here, in one embodiment, the genetic markers represented by the genetic data 202 are Single Nucleotide Polymorphisms (SNPs), which are a popular type of genetic marker. This genetic information, passed from parents to offspring, is unique to each plant and can be identified to track genotypes. A SNP is a polymorphic DNA sequence on a chromosome that can track inheritance. SNPs have two alleles (variations of A, C, G, T) for each marker, e.g., A and G. The genotype, or genetic makeup, at a SNP marker can be homozygous (AA, GG) or heterozygous (AG/GA), which are digitized alphabetically as +1, −1, and 0, respectively, for computational purposes. In other embodiments, the genetic markers may be restriction fragment length polymorphisms (RFLPs), variable number of tandem repeats (VNTRs), microsatellites, and/or copy number variants (CNVs)

Here, in one embodiment, thousands of SNP marker data points were used as the input genetic data. Specifically, the genetic data input into the trained machine-learning algorithm was represented as a vector of approximately 5,000 dimensions for corn and approximately 12,000 dimensions for soy, with each number in the vector representing a specific genetic marker related to a particular seed product (germplasm). A representation of the genetic input data for corn is shown below in Table 1:

| | Marker | Marker | Marker | Marker | Marker | Marker | | | Marker |
|---|---|---|---|---|---|---|---|---|---|
| | 1 | 2 | 3 | 4 | 5 | 6 | . . . | . . . | 5123 |
| Germplasm | −1 | 1 | 1 | 0 | −1 | 1 | . . . | . . . | 1 |
| 1 | | | | | | | | | |
| Germplasm | 0 | 1 | 1 | 0 | 1 | 0 | . . . | . . . | 1 |
| 2 | | | | | | | | | |
| . . . | . . . | . . . | . . . | . . . | . . . | . . . | . . . | . . . | . . . |

The marker values in Table 1 are from −1 to 1 representing if the alleles for the markers are homozygous or heterozygous. For example, for marker alleles of (A,G), −1 is AA (homozygous, larger allele by alpha), 1 is GG (homozygous, lower allele by alpha), 0 is for AG or GA (heterozygous).

The trained machine-learning algorithm 204 generates genetic embeddings 206, which can be understood in the art to be vectors in high-dimensional space. In this case, the genetic embeddings 206 are of size 20 to 40, meaning they can be visualized as vectors in 20-dimensional to 40-dimensional space. It should be noted, however, that even in this high-dimensional space (i.e. higher than the conventional three dimensions), the dimensions (e.g. 20-40) are still lower than the dimensions of the input vectors (e.g. 5,000-12,000 dimensions). Also as understood in the art, the trained machine-learning algorithm 204 is trained in such a way that the outputted genetic embeddings 206 encode information in the high-dimensional space. For example, two embedding vectors whose endpoints are close to each other in the embeddings space likely correspond to seed products that are similar genetically.

Various techniques may be employed to implement the trained machine-learning algorithm 204. In one embodiment, the trained machine-learning algorithm 204 may be implemented using Principal Component Analysis (PCA). PCA is a dimensionality reduction method, used in this case to manage the high-dimensionality of the SNPs. In other words, PCA is used here to transform complex, high-dimensional genetic marker data into a more manageable, lower-dimensional space. Generally, there are four steps in the PCA Implementation. The first step is covariance matrix computation. Following standardization, the covariance matrix of the data was computed to understand how the dimensions vary from the mean with respect to each other. In standardization, the data is standardized so that each SNP data feature has a mean of zero and a standard deviation of one. The covariance matrix captures how each SNP varies with every other SNP, essentially reflecting the relationships between them. The second step is eigenvalue decomposition. The covariance matrix was then decomposed into its eigenvalues and eigenvectors. These eigenvectors represent the directions of maximum variance, known as principal components, and the eigenvalues denote the magnitude of these directions. The third step is the selection of principal components. A subset of principal components that capture the most variance in the data was selected to transform the original high-dimensional data into a lower-dimensional space (i.e. the embedding). And finally, the fourth step is transformation. The original dataset was transformed into this new lower-dimensional space using the selected principal components.

The training of the PCA implementation requires both a training dataset and a validation dataset. In one embodiment, the training dataset is a genetic marker dataset of over 11,000 markers characterizing over 10,000 soy varieties. A large dataset is desirable because it allows for a comprehensive analysis of the genetic diversity and patterns within the training dataset. The validation dataset, which is used to evaluate the quality of the generated embeddings, consists of approximately 1,000 soy varieties with the same 11,000 markers. The validation dataset was employed to assess the PCA model's performance and its ability to generalize across different genetic backgrounds.

The effectiveness of the PCA embeddings, as well as the embeddings generated by the autoencoder implementation described below, was evaluated based on metrics outlined in “Towards a Comprehensive Evaluation of Dimension Reduction Methods for Transcriptomic Data Visualization,” by Huang et al., available at https://www.nature.com/articles/s42003-022-03628-x. This evaluation focuses on two key aspects. The first is local structure evaluation. This involves assessing the integrity of clusters within the embeddings. The aim was to determine how well the PCA managed to group products with similar genome information (genetic clusters) in the reduced-dimensional space. The second is global structure evaluation. This aspect evaluates the embeddings based on their ability to maintain the global relationships between different clusters, ensuring that distinct genetic clusters are appropriately separated in the embedding space.

In another embodiment, the trained machine-learning algorithm 204 may be implemented using an autoencoder. An autoencoder is an unsupervised neutral network that typically has an encoder portion that performs feature extraction, reduces data size, and generates embeddings in a latent space, and a decoder portion that uses the generated embeddings to reconstruct the original data. In this example, because only the latent space representations of the input data are of interest, the trained machine-learning algorithm 204 may be implemented with only the encoder portion of the autoencoder and not the decoder. The encoder portion of the autoencoder is used to perform feature extraction of the input data, i.e., the genetic data 202, to generate latent-space representations, which are also known as embeddings. That is, the decoder may be implemented while the machine-learning algorithm 204 is being trained, in order to determine how well the predicted output of the machine-learning algorithm 204 matches the input. However, once trained, the decoder may not be further used.

In one embodiment, the autoencoder is implemented with six layers, excluding the input layer. The six layers are two dense intermediate layers, a bottleneck layer, two dense decoding layers, and an output layer. The bottleneck layer represents the compressed representation of the input data. The decoding layers mirror the intermediate layers. The output layer is a dense layer whose size matching the input layer, and is designed to reconstruct the original input data from the latent representation.

The model is compiled using the Adam optimizer and a loss function is used to train the autoencoder. In one embodiment, the loss function is the Mean Squared Error (MSE). The MSE calculates the average of the squares of the differences between the predicted values (output of the autoencoder) and the actual values (input data to the autoencoder). The goal during the training of the autoencoder is to minimize this loss function, which indicates that the reconstructed outputs are as close as possible to the original inputs, thereby ensuring the autoencoder effectively learns a compact representation (in the latent space) of the input data. Additionally, the encoder is created by extracting the model up to the bottleneck layer. This encoder model can be used to generate the latent space representations (embeddings) of input data. The training and validation datasets are the same as those used in the Principal Component Analysis (PCA) approach described above.

In this embodiment, the autoencoder is also implemented with the following tunable parameters:
input_shape: a tuple specifying the shape of the input data. The autoencoder expects input data of this shape.
latent_dim: the size of the latent space, which is a compressed representation of the input data.
intermediate_dim: a list specifying the sizes of the intermediate layers between the input layer and the latent space. In this embodiment, intermediate_dim specifies two layers with sizes 512 and 256.
bottleneck_activation: the activation function used in the bottleneck layer (latent space). In this embodiment, the activation function is “linear.”
code_activation: the activation function used in the intermediate (code) layers. In this embodiment, the activation function is “relu” (Rectified Linear Unit).
output_activation: the activation function used in the output layer. In this embodiment, the activation function is “sigmoid.”
measure_loss: the loss function used to train the autoencoder. As noted above, In this embodiment, the activation function is “mean_squared_error.”
batch_size: the size of the batches of data (number of samples) to work through before updating the internal model parameters. In this embodiment, the batch size is 128.
epochs: the number of complete passes through the training dataset. In this embodiment, the number of epochs is 50.

It should be noted that the disclosed autoencoder is not limited to the specific embodiment disclosed above. In particular, the parameters listed above as well as the architecture of the model (e.g. the type and number of layers) are customizable based on specific needs.

After the process shown in FIG. 2, the dimensionality of the data set is reduced, and accordingly the demanding task of processing high-dimensional genetic seed data can be handled more efficiently. That is, the original data vectors of size 5,000 in the input data 202 are reduced to size 40, for example, in the output data 206. This way, because the data set is now smaller, it can be processed or otherwise manipulated more easily and more efficiently. This process condenses genetic information (e.g. markers) into a form that captures underlying patterns and relationships. It transforms high-dimensional genetic data into a lower-dimensional space, preserving the essential features of the data. As explained above, information is encoded in the high-dimensional embeddings space, such that seed products that are similar genetically are likely represented by vectors that are close together in the embeddings space. However, this high-dimensional embeddings space still has fewer dimensions that the high-dimensional genetic data. Thus, vectors in the embeddings space can be clustered together to generate categories or groups of genetically-similar seed products. Any number of clustering techniques may be employed to implement this clustering step, such as hierarchical clustering, centroid-based clustering, and kernel density-based clustering.

Hierarchical clustering is a method of cluster analysis which seeks to build a hierarchy of clusters. In the context of genetic clustering, hierarchical clustering can be used to group products (such as corn or soy varieties) based on their genetic marker data. By evaluating the genetic similarities, products within the same cluster are expected to have similar genome information, which may be indicative of similar performance in agricultural contexts. This approach allows for the identification of product groups with potentially similar traits, such as yield or disease resistance, without predefined group boundaries. Hierarchical clustering's flexibility in not requiring a predetermined number of clusters and its intuitive dendrogram output make it particularly useful for exploratory data analysis in genetics and other fields. Hierarchical clustering can be done using either bottom-up aggregation or top-down split. For the aggregation type hierarchical clustering, each data object is regarded as a separate cluster initially. Then according to similarities calculated among all the data objects, the two data objects that having the maximum similarity (e.g., minimum distance) are merged into the same cluster, and the new cluster is represented by the mean value of the two data objects in the cluster. The similarities among the new cluster and other cluster are calculated again, and the most similar two clusters are merged into one cluster. These steps are iterated until all the data objects are clustered. In contrast, the steps of split type hierarchical clustering are just opposite to those of aggregation type method. That is, all the data objects together are grouped into one cluster initially, and splitting operation is iteratively conducted until each data object is in its own cluster.

Centroid-based clustering, such as k-means, groups data based on closeness to a central point or centroid. It iteratively reassigns data points to the nearest cluster and recalculates centroids until clusters stabilize. This method is efficient but requires specifying the number of clusters upfront and is sensitive to initial centroid positions.

Kernel density-based clustering identifies clusters without a predefined number of clusters by finding local density maxima. It shifts data points towards higher density areas until convergence, grouping points that converge to the same maximum. This approach adapts well to clusters of various shapes and sizes but depends on the choice of the bandwidth parameter, which affects density estimation scale.

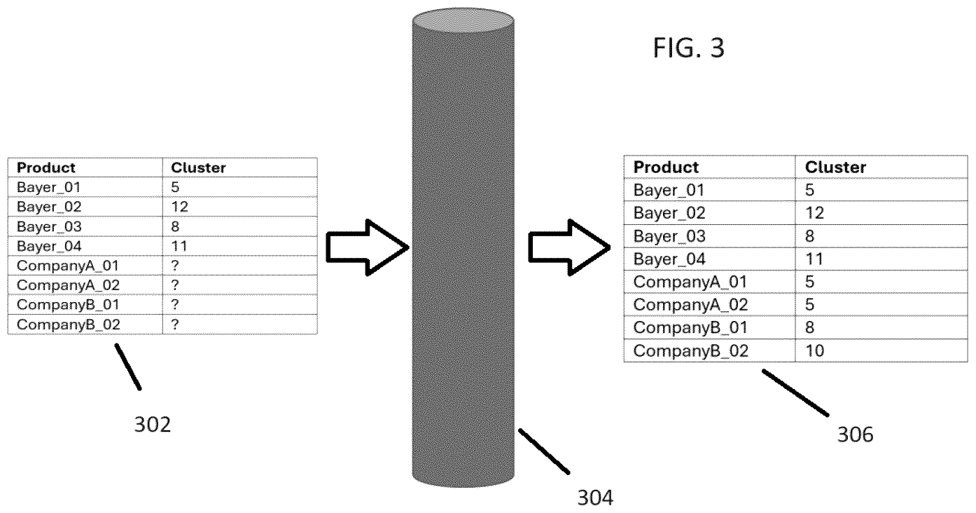

FIG. 3 illustrates a schematic diagram of a machine-learning algorithm to generate seed product recommendations based on products from multiple competitor companies. The genetics-based algorithm discussed above in connection with FIG. 2 may be only applicable to one seed manufacturer. For example, Bayer CropScience™ may implement the FIG. 2 algorithm on its own Bayer-branded seeds because it only has access to the genetic information of its own seeds. When the FIG. 2 algorithm is performed, the end result of the algorithm may be the first four rows of the input table 302 in FIG. 3. In other words, in one embodiment, the genetic data of various different seed products, in this case Bayer_01, Bayer_02, Bayer_03, and Bayer_04, are inputted into an autoencoder algorithm, for example, to generate embeddings, and those embeddings are clustered. The results of the clustering are shown in FIG. 3. For example, Bayer_01 is located in cluster 5, Bayer_02 is located in cluster 12, Bayer_03 is located in cluster 8, and Bayer_04 is located in cluster 11.

Such an algorithm that only processes data from a single seed manufacturer may not be commercially useful. That is, a grower may be interested in not only the various seed brands from a single manufacturer, but also seed products from other manufacturers. Therefore, for an algorithm to recommend seed products, it would be advantageous for that algorithm to be capable of recommending seeds from any number of manufacturers. However, as shown above, an algorithm based on genetics information may be constrained in this respect because the genetics information of commercially-available seeds (e.g., the seeds' genome) is typically not publicly available. And accordingly, typically, a company may only be able to practice the algorithm of FIG. 2 on its own seeds, and thus will not be able to make recommendations with respect to competitors' seeds.

The algorithm of FIG. 3 solves this problem by clustering competitor seeds with a manufacturer's own seeds based on agronomic data, not genetic data. Unlike genetic data, agronomic data of competitor seeds is likely known or is likely publicly available. For example, a seed manufacturer may have various data points regarding a competitor's seed product, such as relative maturity, plant height, car/pod height for corn and soy, respectively, emergence, standability, phytophthora root and stem rot (PRR), pubescence, etc. These agronomy data points may be generally categorized into two types of data: product characteristics information and product planting information. Product characteristics information include, for example, relative maturity, plant height, maturity group, which is an assigned value based on the relative maturity of a soybean product, car/pod height for corn and soy, respectively, etc. Product planting information include, for example, longitude and latitude of planting location, planting date or week, etc. A trained machine-learning algorithm 304 is used to insert competitor seed products into existing clusters based on similarities in the agronomic data. For example, as shown in the output 306, the seed product Bayer_01 and competitor product CompanyA_01 are both grouped into cluster 5, based on various similarities in the agronomic data of Bayer_01 and CompanyA_01. For example, Bayer_01 and CompanyA_01 may have similar plant heights.

The output 306 can be used to generate recommendations to the grower. For example, if a grower previously had success planting Bayer_01 in a particular field or growing space 103, in one embodiment, the artificial-intelligence based system disclosed herein may recommend that the grower also plant CompanyA_01 seeds or CompanyA_02 seeds in the next planting season. As shown in FIG. 3, this is because all three seed products, Bayer_01, CompanyA_01 seeds, and CompanyA_02, belong to the same cluster in the embeddings space.

In one embodiment, the trained machine-learning algorithm 304 may be implemented using random forest. Random forest algorithms are an ensemble learning method used for classification and regression tasks. For classification tasks, random forest operates by constructing multiple decision trees during training and outputting the mode of the classes of the individual trees. In this embodiment, the random forest configuration employs a random forest classifier with n_estimators=1500 trees in the forest. The random forest model is trained using a dataset with features (i.e. agronomic data) and responses (i.e. genetic cluster), focusing on the capability to predict for those products with missing genetic markers, e.g., products from CompanyA above. In one specific embodiment, the features or agronomic data used in the training of the random forest model are maturity group and/or relative maturity, longitude, latitude, and planting week.

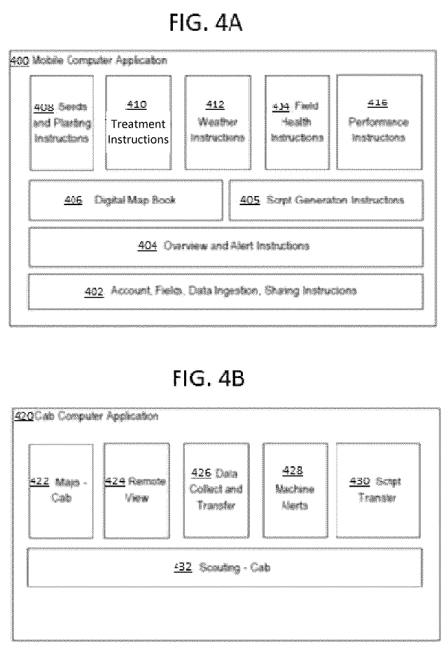

FIGS. 4A and 4B illustrate two views of an example logical organization of sets of instructions in main memory when an example mobile application is loaded for execution. In FIGS. 4A and 4B, each named element represents a region of one or more pages of RAM or other main memory, or one or more blocks of disk storage or other non-volatile storage, and the programmed instructions within those regions. In one embodiment, in FIG. 4A, a mobile computer application 400 comprises account, fields, data ingestion, sharing instructions 402, overview and alert instructions 404, digital map book instructions 406, seeds and planting instructions 408, treatment instructions 410, weather instructions 412, field health instructions 414, and performance instructions 416.

In one embodiment, a mobile computer application 400 comprises account, fields, data ingestion, sharing instructions 402 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 400 comprises a data inbox. In response to receiving a selection of the data inbox, the mobile computer application 400 may display a graphical user interface for manually uploading data files and importing uploaded files to a data manager.

In one embodiment, digital map book instructions 406 comprise field map data layers stored in device memory and are programmed with data visualization tools and geospatial field notes. This provides growers with convenient information close at hand for reference, logging and visual insights into field performance. In one embodiment, overview and alert instructions 404 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 408 are programmed to provide tools for seed selection, hybrid placement, and script creation, including variable rate (VR) script creation, based upon scientific models and empirical data. This enables growers to improve and/or maximize yield or return on investment through optimized seed purchase, placement and population.

In one embodiment, script generation instructions 405 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 400 may display one or more fields broken into management zones, such as the field map data layers created as part of digital map book instructions 406. In one embodiment, the management zones comprise soil zones along with a panel identifying each soil zone and a soil name, texture, drainage for each zone, or other field data. Mobile computer application 400 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 400 may make the script available for download in a format readable by an application controller, such as an archived or compressed format. Additionally, and/or alternatively, a script may be sent directly to a cab computer from mobile computer application 400 and/or uploaded to one or more data servers and stored for further use.

In one embodiment, treatment instructions 410 are programmed to provide tools to inform treatment decisions by visualizing the availability of treatments to crops. This enables growers to improve and/or maximize yield or return on investment through the parameters of certain treatments (e.g., nitrogen, fertilizer, fungicides, other nutrients (such as phosphorus and potassium), pesticide, and irrigation, etc.) applied during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others.

In one embodiment, weather instructions 412 are programmed to provide field-specific recent weather data and forecasted weather information. This enables growers to save time and have an efficient integrated display with respect to daily operational decisions.

In one embodiment, field health instructions 414 are programmed to provide timely remote sensing images highlighting in-season crop variation and potential concerns. Example programmed functions include cloud checking, to identify possible clouds or cloud shadows; determining indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 416 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 416 may be programmed to communicate via the network(s) to back-end analytics programs executed at agricultural computer system 116 and/or external data server computer 114 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer. For example, referring now to FIG. 4B, in one embodiment a cab computer application 420 may comprise maps-cab instructions 422, remote view instructions 424, data collect and transfer instructions 426, machine alerts instructions 428, script transfer instructions 430, and scouting-cab instructions 432. The code base for the instructions of FIG. 4B may be the same as for FIG. 4A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 422 may be programmed to provide map views of fields, farms or regions that are useful in directing machine operation. The remote view instructions 424 may be programmed to turn on, manage, and provide views of machine activity in real-time or near real-time to other computing devices connected to the system 100 via wireless networks, wired connectors or adapters, and the like. The data collect and transfer instructions 426 may be programmed to turn on, manage, and provide transfer of data collected at sensors and controllers to the system 100 via wireless networks, wired connectors or adapters, and the like. The machine alerts instructions 428 may be programmed to detect issues with operations of the machine or tools that are associated with the cab and generate operator alerts. The script transfer instructions 430 may be configured to transfer in scripts of instructions that are configured to direct machine operations or the collection of data. The scouting-cab instructions 432 may be programmed to display location-based alerts and information received from the system 100 based on the location of the field manager computing device 110, agricultural apparatus 106, or sensors in the field and ingest, manage, and provide transfer of location-based scouting observations to the system 100.

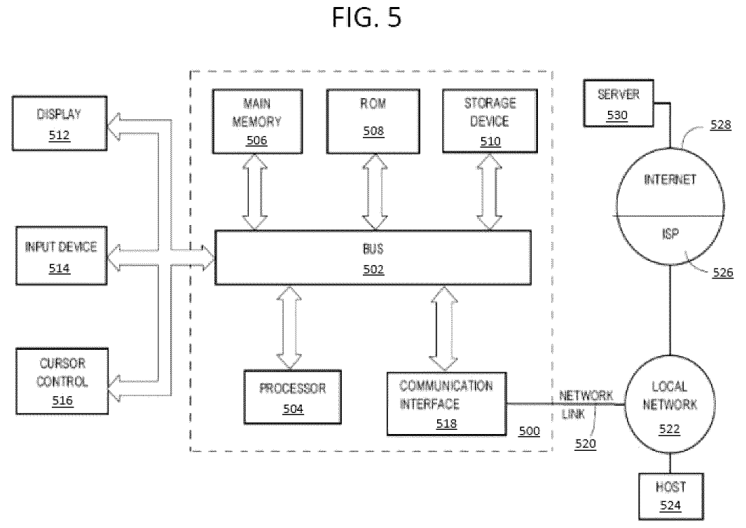

For example, FIG. 5 is a block diagram that illustrates a computer system 500 upon which one or more embodiments of the present disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), liquid crystal display (LCD), light emitting diode (LED), etc., for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device may, for example, have two degrees of freedom in two axes, a first axis (e.g., x, etc.) and a second axis (e.g., y, etc.), that allows the device to specify positions in a plane. The input device 514, more generally, includes any device through which the user is permitted to provide an input, data, etc., to the computer system 500.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 430 might transmit a requested code for an application program through Internet 528, ISP 526, local network 522 and communication interface 518.

The received code may be executed by processor 504 as it is received, and/or stored in storage device 510, or other non-volatile storage for later execution.

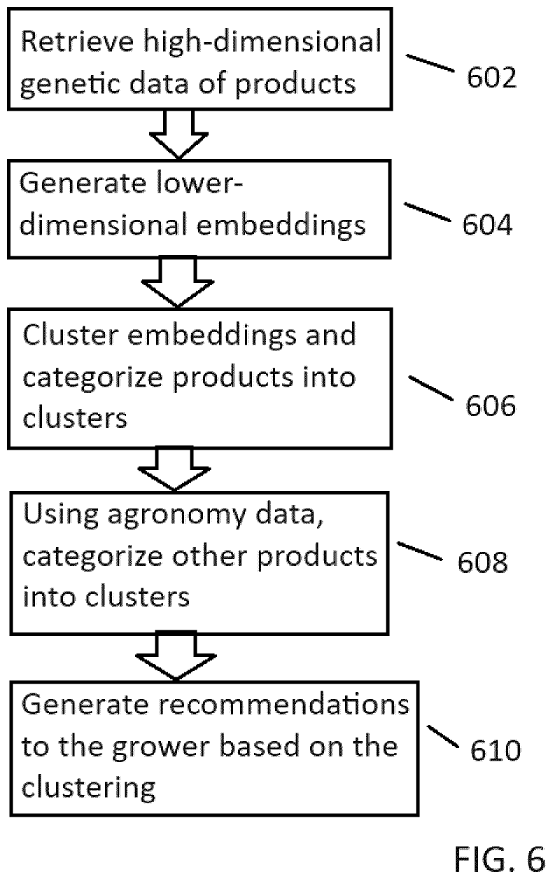

FIG. 6 is a flow chart illustrating a method of the present disclosure in one embodiment. At step 602, a computer system having a processor and a memory coupled to the processor may retrieve high-dimensional genetic data of various products, such as various seed products. As explained above, this genetic data may be organized as a number of data vectors, each vector corresponding to a particular product. The number of values in each vector is commonly referred to in the art as the vector's “dimension.” In one embodiment, a particular vector representing genetic data, such as marker information, may have 5,000 values or dimensions.

At step 604, the computer system generates lower-dimensional embeddings from the high-dimensional genetic data. For example, the dimensionality of the data may be reduced from 5,000 in the input data set to about 20-40 in the embeddings. A supervised or unsupervised machine-learning algorithm may be used to generate the embeddings. For example, step 604 may be implemented using an autoencoder. In the case where the embeddings have a dimension of 40, the embeddings can be understood as vectors in 40-dimensional space. Data features are encoded in the embeddings, such as each dimension in the 40-dimensional space is associated with a particular genetic feature in the genetic data set. And accordingly, vectors whose endpoints are close to each other may correspond to products that are genetically similar.

At step 606, the embeddings are clustered into, for example, twelve clusters. This way, vectors whose endpoints are close to each other may be clustered into the same cluster, and thus each cluster may contain products that are all genetically similar to each other. This clustering step may be implemented with a number of techniques known in the art, such as hierarchical clustering, centroid-based clustering, and kernel density-based clustering.

At step 608, products whose genetic information is unknown are added to the clusters. In one embodiment, these products may be competitor products or products from other manufacturers, where their genetic information is not made publicly available. In this case, the owner or operator of the computer system performing the method shown in FIG. 6 does not have access to the genetic information of these products. Therefore, instead of adding these products to the clusters based on genetic data, they are added to the clusters based on agronomy data. For example, one of these products without known genetic data may be added to a particular cluster when this product exhibits similar phenotypes (e.g. plant height) as one of the existing products in the particular cluster that was added to the cluster based on its genetic information.

Finally, at step 610, the computer system generates recommendations to a grower or farmer based on the clusters that were generated in step 608. For example, if a grower has previously successfully grown a particular seed product in a particular cluster, the computer system may recommend to that grower another product in the same cluster. Interestingly, one advantage of the disclosed invention in one embodiment is that the recommendations are manufacturer-agnostic. That is, because both products owned by the operator of the method and competitor products are included in the clusters, as explained in connection with step 608 above, the disclosed invention in one embodiment can provide recommendations for a large variety of products across a number of different manufacturers. The grower is likely to prefer the recommendation engine as disclosed herein as opposed to a recommendation engine that is limited to the seed products of a single particular manufacturer.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the steps/operations recited in the claims.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are examples in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for generating a seed recommendation, comprising:
at least one processor;
a display communicatively coupled to the at least one processor and configured to display a result based on computations performed by the at least one processor; and
a memory communicatively coupled to the at least one processor, the memory storing executable instructions, which when executed by the at least one processor, cause the at least one processor to:
retrieve genetic data of two or more seed products from a database, the genetic data having a first dimensionality;
using a first artificial-intelligence based algorithm, generate embeddings corresponding to the genetic data, the embeddings having a second dimensionality lower than the first dimensionality;
categorize the embeddings into one or more clusters using a clustering algorithm, such that genetically similar seed products among the two or more seed products are assigned to the same cluster based on the embeddings of the genetically similar seed products;
using agronomy data and a second artificial-intelligence based algorithm, assign additional seed products to the one or more clusters;
generate a recommendation to a grower to plant a first seed categorized in a first cluster, when the grower has previously planted a second seed in the first cluster; and
cause the display to display the generated recommendation to the grower.

2. The system of claim 1, wherein the genetic data comprises genetic marker data.

3. The system of claim 2, wherein genetic markers in the genetic marker data are at least one of single polymorphism nucleotides (SNPs), restriction fragment length polymorphisms (RFLPs), variable number of tandem repeats (VNTRs), microsatellites, and copy number variants (CNVs).

4. The system of claim 1, wherein the first artificial-intelligence based algorithm is based on principal component analysis (PCA) or an autoencoder.

5. The system of claim 4, wherein the autoencoder comprises an encoder portion and a decoder portion, and wherein the first artificial-intelligence based algorithm is the encoder portion.

6. The system of claim 1, wherein the second dimensionality is between 20 and 40 dimensions.

7. The system of claim 1, wherein the agronomy data comprises at least one of product characteristics of the additional seed products and product planting information of the additional seed products.

8. The system of claim 7, wherein the product characteristics includes at least one of relative maturity, plant height, ear/pod height, emergence, standability, phytophthora root and stem rot (PRR), and pubescence, and wherein the product planting information includes at least one of longitude and latitude of planting location and planting date or week.

9. The system of claim 1, wherein the clustering algorithm is one of hierarchical clustering, centroid-based clustering, and kernel density-based clustering.

10. The system of claim 1, wherein the second artificial-intelligence based algorithm is a random forest algorithm.

11. A method for generating a seed recommendation, comprising:
retrieving genetic data of two or more seed products from a database, the genetic data having a first dimensionality;
using a first artificial-intelligence based algorithm to generate embeddings corresponding to the genetic data, the embeddings having a second dimensionality lower than the first dimensionality;
categorizing the embeddings into one or more clusters using a clustering algorithm, such that genetically similar seed products among the two or more seed products are assigned to the same cluster based on the embeddings of the genetically similar seed products;
using agronomy data and a second artificial-intelligence based algorithm to assign additional seed products to the one or more clusters;
generating a recommendation to a grower to plant a first seed categorized in a first cluster, when the grower has previously planted a second seed in the first cluster; and
causing a display to display the generated recommendation to the grower.

12. The method of claim 11, wherein the genetic data comprises genetic marker data.

13. The method of claim 12, wherein genetic markers in the genetic marker data are at least one of single polymorphism nucleotides (SNPs), restriction fragment length polymorphisms (RFLPs), variable number of tandem repeats (VNTRs), microsatellites, and copy number variants (CNVs).

14. The method of claim 11, wherein the first artificial-intelligence based algorithm is based on principal component analysis (PCA) or an autoencoder.

15. The method of claim 14, wherein the autoencoder comprises an encoder portion and a decoder portion, and wherein the first artificial-intelligence based algorithm is the encoder portion.

16. The method of claim 11, wherein the second dimensionality is between 20 and 40 dimensions.

17. The method of claim 11, wherein the agronomy data comprises at least one of product characteristics of the additional seed products and product planting information of the additional seed products.

18. The method of claim 17, wherein the product characteristics includes at least one of relative maturity, plant height, ear/pod height, emergence, standability, phytophthora root and stem rot (PRR), and pubescence, and wherein the product planting information includes at least one of longitude and latitude of planting location and planting date or week.

19. The method of claim 11, wherein the clustering algorithm is one of hierarchical clustering, centroid-based clustering, and kernel density-based clustering.

20. The method of claim 11, wherein the second artificial-intelligence based algorithm is a random forest algorithm.
